(19) United States
(12) Patent Application Publication
(10) Pub. No.: US 2020/0158534 A1
(43) Pub. Date: May 21, 2020

(54) PROCEDURE FOR HANDLING EXCEPTIONAL CONDITIONS OF A MEASUREMENT SYSTEM

(71) Applicant: Endress+Hauser Conducta GmbH+Co. KG, Gerlingen (DE)

(72) Inventors: Tilman Benkert, Stuttgart (DE); Holger Eberhard, Stuttgart (DE); Florian Fetz, Stuttgart (DE)

(21) Appl. No.: 16/658,634

(22) Filed: Oct. 21, 2019

(30) Foreign Application Priority Data
Oct. 19, 2018 (DE) 10 2018 126 078.4

(51) Int. Cl. G01D 1/18

(52) U.S. Cl. CPC G01D 1/18

(57) ABSTRACT

The present disclosure relates to a procedure for handling exceptional conditions of a measurement system. The procedure includes steps of detecting at least one measured value, wherein the measured value represents a value derived from a measurand, and digitizing the measured value. The procedure also includes steps of creating a data structure, wherein the data structure comprises at least the measured value as an element, and adding at least one error code list comprising at least one error code to the data structure if the measurement system or the measured value has an exceptional condition. The error code is specific to the exceptional condition of the measurement system or to the measured value. The present disclosure further relates to a measurement system for carrying out the procedure.

### CROSS-REFERENCE TO RELATED APPLICATION

The present application is related to and claims the priority benefit of German Patent Application No. 10 2018 126 078.4, filed on Oct. 19, 2018, the entire contents of which are incorporated herein by reference.

### TECHNICAL FIELD

The present disclosure relates to a procedure for handling exceptional conditions of a measurement system and to a corresponding measurement system for carrying out the procedure.

### BACKGROUND

Measurement systems in process automation typically provide a self-diagnostic functionality which identifies and reports exceptional conditions, such as the failure of subcomponents, exceeding of certain limit values, etc. For this purpose, a list of all active exceptional conditions of the system is often displayed as numerical codes with a textual description. Usually, a category is also assigned to each code according to NAMUR recommendation NE107. If the system is connected to a fieldbus, the same information is also transmitted digitally to a control room in the specific coding. If the measurement system consists of different components, information about the component for which the exceptional condition was identified is also added to the codes in some devices.

At the outputs of the system (current outputs, relays, fieldbus device variables, etc.), a special status is determined from the list of active condition codes and appended to the output value (fieldbuses) or the output value is set to a specific value (residual current). For fieldbuses, this status typically consists of a classification of “good,” “uncertain” or “bad.” However, it does not contain any information about the cause or source of this classification. There is no uniform procedure for determining this status from the condition code list. Unintentional or unexpected behavior therefore easily occurs, precisely in the case of more complex measurement systems, when exceptional conditions occur.

One possible procedure is to determine a list of resulting output statuses using the list of all active condition codes via a table containing per output the output status resulting from the condition code. By means of a prioritization, this list is aggregated, usually in such a way that the worst output status prevails, to an output status, which is output together with the output value at the output.

This procedure provides a correlation between exceptional condition and status but, when only one intermediate processing component is added between source and output, it is already no longer able to determine whether the measured value originally comes from the source with the exceptional condition or another source.

Another known procedure is to already determine the output status at the output of the source and to propagate it through the chain of signal processing components to the output, wherein each signal processing component modifies the output status, usually such that the output status always remains the same or deteriorates but never improves. In the case of fieldbus outputs, a recoding to the coding of the output status required by the respective fieldbus standard generally also takes place.

The procedure mentioned second has the advantage that, even in the case of longer processing chains of the measured values, the information is maintained as to which measured values are affected and which are not. For this purpose, the information as to which exceptional condition has caused the output status is completely lost.

A combination of the two procedures can partially mitigate some of the disadvantages but makes the device behavior even more difficult to understand.

The more complex the measurement system (for example, a transmitter with a plurality of connected sensors) is or the more components the measurement system has, the more difficult it is to comprehend the consequences of a specific exceptional condition or even a plurality of simultaneous exceptional conditions. The system may have complicated measured value processing chains which cannot be correctly considered in the conventional procedure of a condition code list. For example, the measured values of a plurality of sensors are mathematically processed in a redundancy module, and the result value is then forwarded to a limit value transmitter, which then generates a binary signal, which in turn is output via a relay and onto a digital fieldbus (e.g., PROFIBUS). If an exceptional condition occurs somewhere in this measured value processing chain, it can directly or indirectly influence the output values of one or more parts of the processing chain emanating from there.

In doing so, achieving precisely the desired output status at all outputs and showing the cause of the output status comprehensibly to the operator, has in any case not been successful in the past. The list of active exceptional conditions was displayed to the operator on the one hand, and the status for each output value was provided on the other hand.

### SUMMARY

The present disclosure is based on the object of establishing a unique correlation between exceptional conditions and output statuses. In other words, the correct output status should also be determined for long, complex processing chains. Furthermore, it should be possible to precisely show the operator at the outputs which exceptional conditions have led to the status.

The object is achieved by a procedure for handling exceptional conditions of a measurement system, the procedure comprising the steps of: detecting at least one measured value, such as by at least one sensor, wherein the measured value represents a value derived from a measurand; digitizing the measured value; creating a data structure, wherein the data structure comprises at least the measured value as an element and/or the data structure comprises the measured value and the unit of the corresponding measurand; and adding at least one error code list comprising at least one error code to the data structure if the measurement system or the measured value has an exceptional condition, wherein the error code is specific to the exceptional condition of the measurement system or to the measured value.

The present disclosure relates to a procedure for measurement systems for the handling and display of exceptional conditions. The object here is to determine an appropriate status at each output and to make comprehensible which exceptional conditions are responsible for this status. This is solved by a list of condition codes which, together with the measured values, pass through the entire processing chain from the source to the output.

One exemplary embodiment provides that an exceptional condition is an error, failure, failure of individual components, exceeding of limit values, insufficient voltage supply or power supply or energy supply, interference of a communication, recognition of invalid data or invalid measured values, warnings of an expected failure, identification of a specific operating mode and/or lack of resources, etc.

Another embodiment provides that the data structure additionally comprises attributes of the measurement system and/or of the sensor, such as measuring range, condition, time stamp of the detection of the measured value, etc.

Another embodiment provides that the error code comprises an alphanumeric error code, an error classification, such as according to NAMUR NE107, a subordinate error code and/or information about the location of the occurrence of the error code.

Another embodiment provides that the measured value is detected by means of a sensor and that more than one measured value is determined by the sensor.

Another embodiment provides that a separate data structure is created for each measured value.

Another embodiment provides that an error code is only entered into the data structure if its corresponding exceptional condition influences, relates to or impairs at least one element of the data structure.

Another embodiment provides that an error code is entered in all data structures which each contain at least one element which is influenced or impaired by the corresponding exceptional condition or related thereto in some other way. The influence can also relate to the error code. The error code is entered as an element of the error code list of a data structure.

Another embodiment provides that the procedure further comprises the following steps: forwarding the data structure to at least one processing unit; and adding at least one further error code to the error code list if the processing unit has an exceptional condition, wherein this error code is specific to the exceptional condition of the processing unit.

Another embodiment provides that an effective error code list is generated on the basis of predefined rules, wherein the effective error code list comprises one or more further error codes and one or more error codes already present in the error code list are deleted.

Another embodiment provides that the processing unit comprises a plurality of inputs for a plurality of data structures.

Another embodiment provides that the processing unit processes, converts or calculates one or more elements of the data structure and/or the processing unit is configured as a redundancy module, temperature compensation module, controller, limit value transmitter, etc. In general, the processing unit is any type of module that mathematically calculates one or more measured values.

Another embodiment provides that the procedure further comprises the following steps: forwarding the data structure to at least one output unit; and outputting at least one element of the data structure, such as the error code list or one or more error codes of the error list. The output unit may also be a processing unit.

Another embodiment provides that before the at least one element of the data structure is output, the error code list is processed and optionally converted on the basis of predefined rules.

Another embodiment provides that the outputting of at least one element comprises the outputting on a display, web server, the forwarding to a fieldbus, device drivers (DD, DTM) or to a current loop.

The object is further achieved by a measurement system for implementing a procedure as described above.

In one embodiment, the measurement system comprises at least one sensor.

### BRIEF DESCRIPTION OF THE DRAWINGS

The present disclosure will be explained in more detail with reference to the following figures.

FIG. 1 shows an exemplary embodiment of a measurement system for carrying out the procedure described herein;

FIG. 2 shows another exemplary embodiment of a measurement system for carrying out the procedure described herein;

FIG. 3 shows yet another exemplary embodiment of a measurement system for carrying out the procedure described herein;

FIG. 4a shows a data structure with its elements or an error code list; and

FIG. 4b shows a data structure with its elements or an error code list.

In the figures, the same features are identified with the same reference signs.

### DETAILED DESCRIPTION

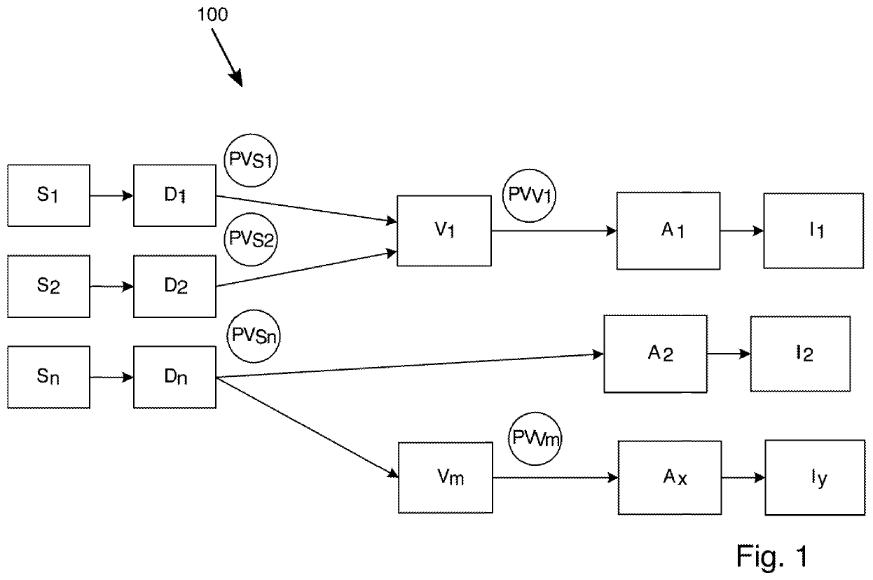

In the example, a measurement system 100, see FIG. 1, consists of the following components, which are designed as software or hardware components: A quantity of sensors S₁ . . . Sₙ, which each generate at least one measured value, usually as a voltage value, via physical or chemical measuring methods. The measured value is a value derived from a measurand. Thus, for instance, the measurand is the pH value, conductivity, turbidity, oxygen content, etc. A measured value is thus detected via a sensor. Alternatively or additionally, a measured value can arrive at the measurement system 100 via an interface, for example via a fieldbus, or the measured value is then detected by the measurement system 100 via the interface. By way of example, the reference sign “S₂” may be understood to mean such an interface.

For each sensor, there is a digitization unit D₁ . . . Dₙ, which converts the measured value into digital data PV_{S1} . . . PV_{Sn}. For the purposes of this application, these digital data PV_{S1} . . . PV_{Sn} are referred to as data structure. A data structure comprises at least the measured value. In one embodiment, the data structure comprises a plurality of elements, that is to say at least the measured (numerical) value and its physical unit. Further elements are, for example, attributes that also include diagnostic information and attributes of the sensor or of the measurement system, such as measuring range, condition, time stamp of the detection of the measured value, etc.

Depending on the system configuration, the data structure is passed to one or more processing units V₁ . . . Vₘ, which convert one or more data structures into other data structures PV_{V1} . . . PV_{Vm}. In particular, one or more elements of the data structure may be converted. The chain of process value processing from the digitization and processing units ends in each case at an output unit A₁ . . . Aₓ, which outputs the appropriately converted data structure via an interface I₁ . . . I_{y} (e.g., display, current loop, fieldbus) to the operator or a control room.

If an exceptional condition now occurs, that is to say, for example, an error, failure, failure of individual components, exceeding of limit values, insufficient voltage supply or power supply or energy supply, interference of a communication, detection of invalid data or invalid measured values, warnings of an expected failure, identification of a specific operating mode and/or lack of resources, the following may occur.

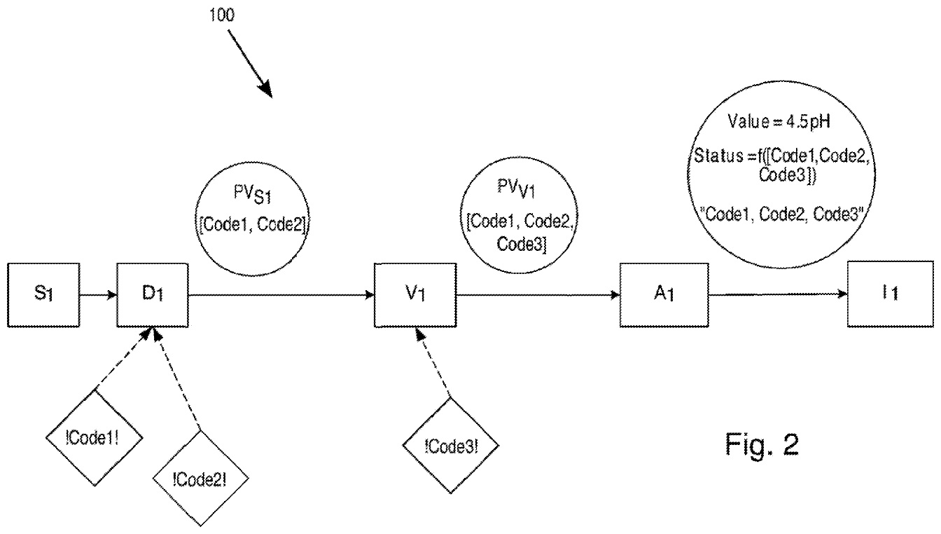

A unique alphanumeric code (referred to herein as “Code1,” “Code2,” etc.) is initially assigned to all exceptional conditions that the measurement system can recognize. See FIG. 2 in this regard. In addition, it is determined for each error code how a value associated therewith is to be handled. These behavior rules may be defined differently for each system component of the measurement system 100.

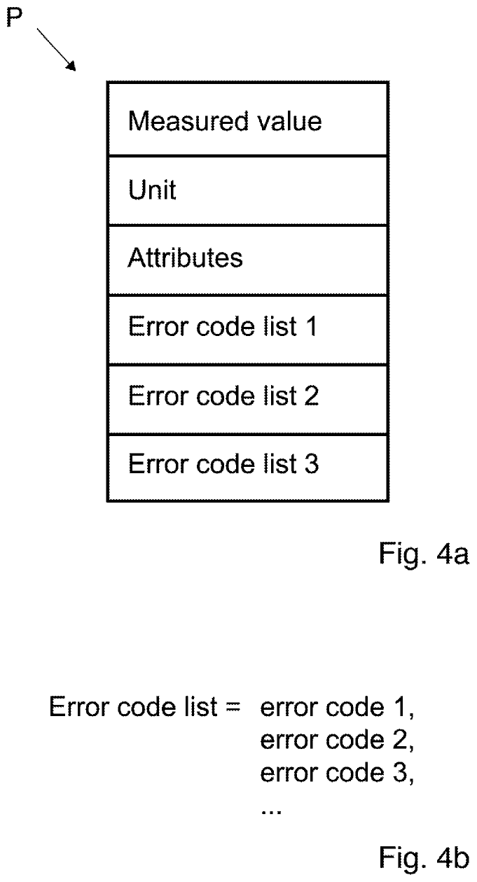

If an exceptional condition, for example, “Code1” or “Code2” (etc.; the error code is generally an alphanumeric value) is now recognized at one of the digitization units D₁ . . . Dₙ or processing units V₁ . . . Vₘ, said unit enters the code into an error code list, which represents an element in the data structure. See FIG. 4a in this regard. Multiple error code lists are also possible. Each error code list contains one or more error codes, see FIG. 4b in this regard. In a processing unit, the error code list of the received data structure is respectively expanded by the recognized exceptional conditions or its corresponding error codes or, particularly in the case of processing units having a plurality of inputs, an effective error code list is determined from the incoming error code list(s) via predefined behavior rules, which error code list is expanded by the error codes of the processing unit and entered for the output process values. Thus, in a first case, an amount of n error codes may be added. In a further case, n error codes are added, but a number of m error codes are also removed.

The approach is generally such that an error code is only entered into the data structure impaired by the exceptional condition (see example below). If an exceptional condition is detected which impairs the function of the entire measurement system 100 (e.g., an insufficient voltage of the power supply), the corresponding condition code is appended to all data structures of system 100.

At each output unit A₁ . . . Aₓ, the interface-specific status or substitute value can on the one hand now be determined from the list of codes of the incoming data structure and the list of the codes causing this status or substitute value can be output on the other hand. This error code list, or individual error codes, is displayed to the operator via the GUI interfaces (e.g., display, web server) and device drivers (e.g., DD, DTM). The display may be limited, if necessary, e.g., to the error code whose response actually significantly determines the output status.

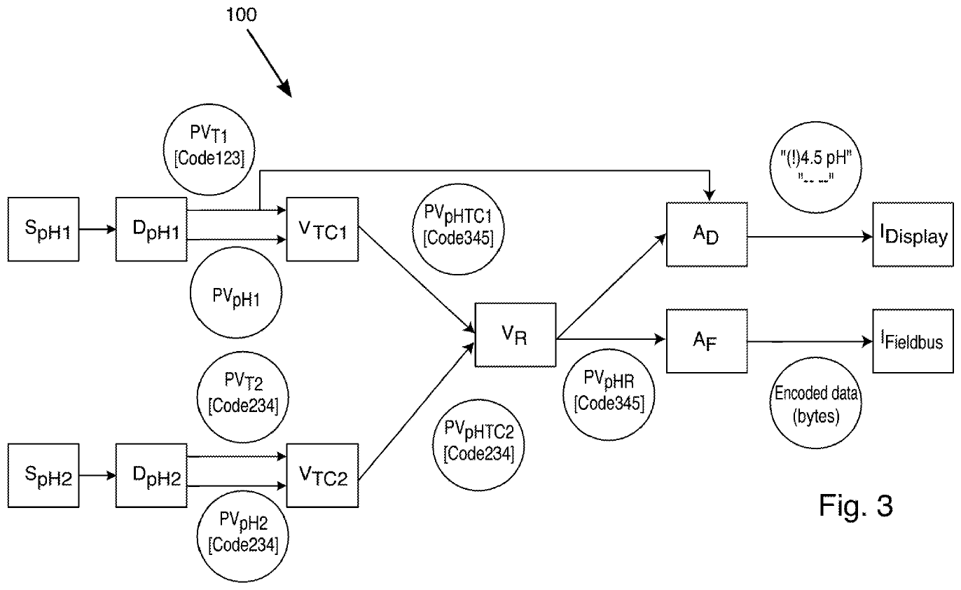

FIG. 3 shows two sensors S_{pH1}/S_{pH2}, which each deliver a pH value and a temperature value, which are delivered via the corresponding digitization units D_{pH1}/D_{pH2} as process values PV_{pH1} and PV_{T1} as well as PV_{pH2} and PV_{T2} to a respective temperature compensation module V_{TC1}/V_{TC2}.

The measurement system 100 comprises a redundancy module that receives the process values PV_{pHTC1} and PV_{pHTC2} from the temperature compensation modules V_{TC1}/V_{TC2} and delivers the “better” of the two as process value PV_{pHR} to two output units A_{D} and A_{F}.

The measurement system 100 comprises an output unit A_{D}, which outputs the process value as text on a display I_{Display}.

The measurement system 100 comprises an output unit A_{F}, which outputs the process value as coded digital data on a fieldbus interface I_{Fieldbus}.

An exceptional condition “123 temperature sensor defective” was detected at the digitization unit D_{pH1}. An exceptional condition “234 invalid calibration data” was detected at the digitization unit D_{pH2}.

In addition, process value PV_{T1} is passed directly to the output unit A_{D}, which outputs this process value as additional text on a display I_{Display}.

The digitization unit D_{pH1} enters the code 123 into the error code list of the data structure PV_{T1} but not for PV_{pH1} since this process value is not affected by the exceptional condition.

The digitization unit D_{pH2} enters the code 234 for both process values PV_{pH2} and PV_{T2}.

The temperature compensation module V_{TC1} evaluates the error code lists of the two input process values. These error code lists cause PV_{T1} to be classified as “bad” and PV_{pH1} to be classified as “good.” According to a predetermined rule of the temperature compensation module, the status “bad” for the temperature value means that there is an exception “345 unreliable temperature compensation.” The temperature-compensated output process value PV_{pHTC1} therefore receives an error code list containing the code 345 (and only this one).

The temperature compensation module V_{TC2} evaluates the error code lists of the two input process values. These error code lists cause both PV_{pH1} and PV_{T1} to be classified as “bad.” According to a predetermined rule of the temperature compensation module, being that the output value must not be classified better than the incoming pH value, an error code list is therefore appended to the temperature-compensated output process value PV_{pHTC2}, which list contains code 234, i.e., the list of the incoming pH value is forwarded.

The redundancy module V_{R} evaluates the error code lists of the two input process values PV_{pHTC1} and PV_{pHTC2}. These error code lists cause PV_{pHTC1} to be classified as a “better” value and to be forwarded (with the error code list with code 345) as PV_{pHR}.

The output unit A_{D} evaluates the code 345 of PV_{pHR} and determines that this code classifies the process value as “uncertain.” According to a predetermined rule, it outputs a text with the value, the unit and a warning symbol “(!)” for “uncertain” on the display I_{Display}.

The output unit A_{F} evaluates the code 345 from PV_{pHR} and also determines that it classifies the process value as “uncertain.” It therefore outputs digital data in the coding of the attached fieldbus I_{Fieldbus}, which contains the value, the unit and a status marker for “uncertain.”

The output unit A_{D} evaluates the code 123 of PV_{T1} and determines that it classifies the process value as “bad.” According to a predetermined rule for this case, it outputs a text with three dashes (“---”) each instead of the value and the unit on the display I_{Display}.

1. A procedure for handling exceptional conditions of a measurement system, the procedure comprising the steps of:
detecting at least one measured value, wherein the measured value represents a value derived from a measurand;
digitizing the measured value;
establishing a data structure, wherein the data structure comprises as an element at least the measured value; and
adding at least one error code list comprising at least one error code to the data structure if the measurement system or the measured value has an exceptional condition;
wherein the error code is specific to the exceptional condition of the measurement system or to the measured value.

2. The procedure of claim 1, wherein an exceptional condition is an error, failure, failure of individual components, exceeding of limit values, insufficient voltage supply or power supply or energy supply, interference of a communication, recognition of invalid data or invalid measured values, warnings of an expected failure, identification of a specific operating mode or lack of resources.

3. The procedure of claim 1, wherein the data structure includes measuring range, condition, or time stamp of the detection of the measured value.

4. The procedure of claim 1, wherein the error code comprises an alphanumeric error code, an error classification, a subordinate error code or information about the location of the occurrence of the error code.

5. The procedure of claim 1, wherein the measured value is detected using a sensor and more than one measured value is determined by the sensor.

6. The procedure of claim 1, wherein a separate data structure is created for each measured value.

7. The procedure of claim 1, wherein an error code is entered into the data structure if its corresponding exceptional condition influences at least one element of the data structure.

8. The procedure of claim 1, wherein an error code is entered into all data structures which each contain at least one element that is influenced by the corresponding exceptional condition.

9. The procedure of claim 1, further including:
forwarding the data structure to at least one processing unit; and
adding at least one additional error code to the error code list if the processing unit has an exceptional condition, wherein the error code is specific to the exceptional condition of the processing unit.

10. The procedure of claim 1, wherein an effective error code list is generated on the basis of predefined rules, wherein the effective error code list comprises one or more further error codes and one or more error codes already present in the error code list are deleted.

11. The procedure of claim 9, wherein the processing unit comprises a plurality of inputs for a plurality of data structures.

12. The procedure of claim 9, wherein the processing unit processes, converts or calculates one or more elements of the data structure.

13. The procedure of claim 1, further comprising:
forwarding the data structure to at least one output unit; and
outputting at least one element of the data structure.

14. The procedure of claim 13, wherein before the at least one element of the data structure is output, the error code list is processed and converted on the basis of predefined rules.

15. The procedure of claim 1, wherein the outputting of the least one element comprises the outputting on a display, web server, the forwarding to a fieldbus, device driver (DD, DTM) or to a current loop.

16. A measurement system including a computer program product embodied on a computer readable storage medium for handling exceptional conditions of the measurement system, comprising:
computer code for detecting at least one measured value, wherein the measured value represents a value derived from a measurand;
computer code for digitizing the measured value;
computer code for establishing a data structure, wherein the data structure comprises as an element at least the measured value; and
computer code for adding at least one error code list comprising at least one error code to the data structure if the measurement system or the measured value has an exceptional condition;
wherein the error code is specific to the exceptional condition of the measurement system or to the measured value.
